(19) United States
(12) Patent Application Publication
(10) Pub. No.: US 2026/0291345 A1
(43) Pub. Date: Sep. 24, 2026

(54) ELECTRIC COMPRESSOR

(71) Applicant: SANDEN CORPORATION, Isesaki-shi, Gunma (JP)

(72) Inventor: Mikio KOBAYASHI, Isesaki-shi, Gunma (JP)

(21) Appl. No.: 19/490,933

(22) PCT Filed: Aug. 7, 2024
(86) PCT No.: PCT/JP2024/028198

§ 371 Date: Dec. 7, 2025

(30) Foreign Application Priority Data
Sep. 4, 2023 (JP) 2023-143-023

(51) Int. Cl. H02K 11/33; H02K 11/00

(52) U.S. Cl. CPC H02K 11/33; H02K 11/0094; H02K 2211/03

(57) ABSTRACT

An electric compressor includes an inverter including a noise filter circuit portion in which a plurality of electrolytic capacitors is mounted in an upright state, a housing, an inverter accommodation portion that accommodates the inverter, and a cover member that closes an opening of the inverter accommodation portion. The noise filter circuit portion includes a first case member that covers the electrolytic capacitor, one surface of the first case member when viewed from the mounting direction of the electrolytic capacitor with respect to a circuit board is formed in a polygonal shape in which the outline of the electrolytic capacitor is connected by a straight line, and a first heat dissipation sheet following the shape of the one surface of the first case member is disposed between the first case member and the cover member.

### TECHNICAL FIELD

The present invention relates to an electric compressor that compresses a refrigerant.

### BACKGROUND ART

In an inverter-integrated electric compressor, a noise filter circuit including at least a plurality of electrolytic capacitors is mounted, taking measures against electromagnetic noise superimposed on an alternating current supplied from an inverter to an electric motor. In the noise filter circuit, as described in JP-A-2013-36394 (Patent Literature 1), an electrolytic capacitor is covered with a resin cover for seismic reinforcement, and a heat dissipation sheet is disposed between the resin cover and a housing in order to improve heat dissipation.

### CITATION LIST

### Patent Literature

Patent Literature 1: JP-A-2013-36394

### SUMMARY OF INVENTION

### Problems to be Solved by Invention

Meanwhile, in the electric compressor described in Patent Literature 1, since a heat dissipation sheet larger than the upper surface of the resin cover covering the electrolytic capacitor is used, there is a portion that does not contribute to heat transfer from the noise filter circuit to the housing. Therefore, it is conceivable to use a heat dissipation sheet following the shape of the upper surface of the noise filter circuit. However, since the shape of the heat dissipation sheet becomes complicated depending on the arrangement of the electrolytic capacitor, for example, there are possibilities that a reference for attaching the heat dissipation sheet to the upper surface of the noise filter circuit becomes unclear, and that the attaching position is shifted or twisting occurs. When such a defect occurs, the heat transfer efficiency from the noise filter circuit to the housing decreases, and for example, there is a possibility that necessary heat dissipation is unable to be secured.

Therefore, it is an object of the present invention to provide an electric compressor that improves the heat dissipation of a noise filter circuit and the workability of attaching a heat dissipation sheet to the noise filter circuit.

### Solution to Problems

An electric compressor includes an electric motor, a rotating shaft rotated by the electric motor, a compression mechanism driven by the rotating shaft, an inverter including an inverter circuit portion that drives the electric motor and a noise filter circuit portion in which a plurality of electrolytic capacitors that reduces electromagnetic noise is mounted on a first circuit board in an upright state, and a housing that accommodates the electric motor, the rotating shaft, and the compression mechanism. In addition, the electric compressor further includes an inverter accommodation portion provided integrally with the housing and having an opening that accommodates the inverter, and a cover member that closes the opening of the inverter accommodation portion. The noise filter circuit portion includes a first resin cover that covers the plurality of electrolytic capacitors mounted on the first circuit board, and one surface of the first resin cover when viewed from a mounting direction of the plurality of electrolytic capacitors with respect to the first circuit board is formed in a polygonal shape in which outlines of the plurality of electrolytic capacitors are connected by a straight line. Further, a first heat dissipation sheet following the shape of the one surface of the first resin cover is disposed between the one surface of the first resin cover and one of the inner surface of the cover member and the bottom wall of the inverter accommodation portion.

### Effects of Invention

According to the present invention, in the inverter-integrated electric compressor, it is possible to improve the heat dissipation of the noise filter circuit, and it is possible to improve the workability of attaching the heat dissipation sheet to the noise filter circuit.

### BRIEF DESCRIPTION OF DRAWINGS

FIG. 1 is a longitudinal sectional view showing an example of an inverter-integrated electric compressor.

FIG. 2 is a perspective view showing an example of an inverter and an inverter accommodation portion.

FIG. 3 is an exploded perspective view showing an example of a noise filter circuit portion.

FIG. 4 is a perspective view showing an example of a resin member.

FIG. 5 is an enlarged cross-sectional view showing the periphery of a bus bar of a resin member.

FIG. 6 is a perspective view showing an example of an engagement member.

FIG. 7 is a longitudinal sectional view showing an example of an engagement member.

FIG. 8 is a perspective view showing another example of an engagement member.

FIG. 9 is a longitudinal sectional view showing another example of an engagement member.

FIG. 10 is an illustration of a mold that integrally molds an engagement member.

FIG. 11 is a plan view showing an example of a layout of a plurality of electrolytic capacitors.

FIG. 12 is a perspective view showing an example of a noise filter circuit portion and a heat dissipation sheet.

FIG. 13 is a plan view showing a first exemplary modification of the layout of a plurality of electrolytic capacitors.

FIG. 14 is a plan view showing a second exemplary modification of the layout of the plurality of electrolytic capacitors.

FIG. 15 is a cross-sectional view showing an exemplary modification of the noise filter circuit portion.

### DESCRIPTION OF EMBODIMENTS

Hereinafter, an embodiment for carrying out the present invention will be described in detail with reference to the accompanying drawings. It should be noted that the terms “first”, “second”, and the like used in the following description are merely used to distinguish between similar elements, and do not limit the elements to which the terms are attached. In addition, the embodiment described below is merely an example and should not be construed as limiting the structure.

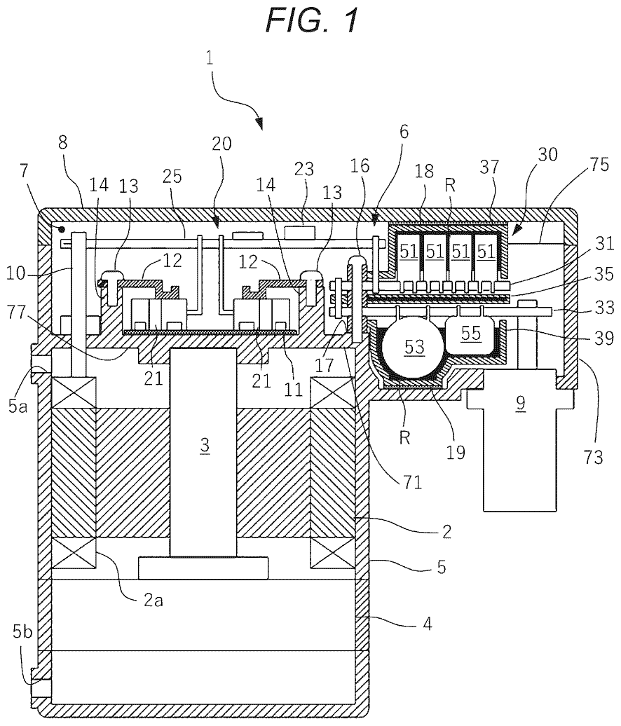

FIG. 1 shows an example of an inverter-integrated electric compressor 1 to which the present invention is applicable. The electric compressor 1 is incorporated in, for example, a refrigerant circuit (not shown) of an air conditioner mounted on a vehicle, and is formed to compress and discharge a refrigerant.

The electric compressor 1 includes an electric motor 2, a rotating shaft 3 rotated by the electric motor 2, a compression mechanism 4 driven by the rotating shaft 3, a housing 5 that accommodates the electric motor 2, the rotating shaft 3, and the compression mechanism 4, an inverter 6 that controls the driving of the electric motor 2, an inverter accommodation portion 7, and a cover member 8.

The electric motor 2 is, for example, a three-phase synchronous motor such as a brushless DC motor, and is driven by power supplied from the inverter 6. The rotating shaft 3 is rotatably supported by the housing 5 with a bearing (not shown), and is rotated by the electric motor 2. The housing 5 has a cylindrical cross section and accommodates the electric motor 2, the rotating shaft 3, and the compression mechanism 4. The electric motor 2, the rotating shaft 3, and the compression mechanism 4 are concentrically disposed inside the housing 5.

The inverter 6 includes an inverter circuit portion 20 that drives the electric motor 2 and a noise filter circuit portion 30 that reduces electromagnetic noise. The inverter accommodation portion 7 is provided integrally with the housing 5 and accommodates the inverter 6 in its inside. Specifically, the inverter accommodation portion 7 is provided on the electric motor 2 side of the housing 5. The inverter accommodation portion 7 has a larger projected area than the housing 5. The inverter accommodation portion 7 is formed by a bottom wall 71 and a peripheral wall 73 rising from a peripheral edge of the bottom wall 71, and has an opening 75 facing the bottom wall 71. The opening 75 of the inverter accommodation portion 7 is closed with the cover member 8 in a state where the inverter circuit portion 20 and the noise filter circuit portion 30 constituting the inverter 6 are accommodated in the inverter accommodation portion 7. Note that the cover member 8 is fixed to a peripheral wall (which is also a part of the housing 5) of the inverter accommodation portion 7 with bolts, not shown.

An HV connector (high voltage connector) 9 that supplies DC power from an in-vehicle battery (not shown) to the inverter circuit portion 20 of the inverter 6 is mounted on the bottom wall 71 of the inverter accommodation portion 7. In addition, a part of the bottom wall 71 of the inverter accommodation portion 7 forms a partition wall 77 that partitions the inside of the housing 5 from the inside of the inverter accommodation portion 7.

The housing 5 is formed with an inlet 5a that allows the refrigerant to flow into the housing 5 and an outlet 5b that allows the refrigerant to flow out of the housing 5. The inlet 5a is formed to allow the refrigerant to flow between the partition wall 77 inside the housing 5 and the electric motor 2. The refrigerant flowing from the inlet 5a into the housing 5 passes through the electric motor 2, reaches the compression mechanism 4, and is compressed by the compression mechanism 4. The refrigerant, compressed by the compression mechanism 4, then flows out through the outlet 5b.

The refrigerant flowing from the inlet 5a into the housing 5 is a low-temperature gas refrigerant that has passed through an expansion valve and an evaporator in a refrigerant circuit of an air conditioner mounted on a vehicle. Therefore, the partition wall 77 and the electric motor 2 can be cooled with the refrigerant flowing from the inlet 5a into the inside of the housing 5.

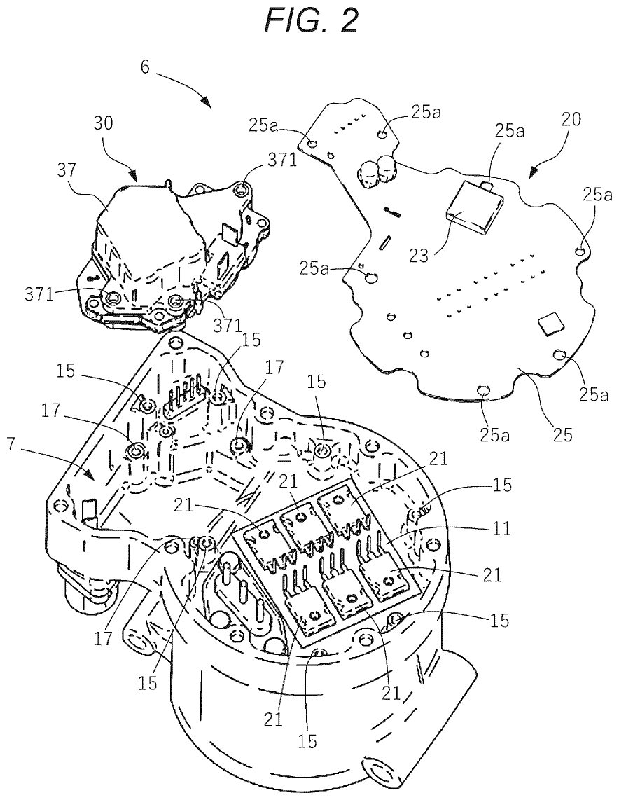

The inverter 6 will be further described with reference to FIGS. 1 and 2. FIG. 2 is a perspective view showing the inverter 6 and the inverter accommodation portion 7. As described above, the inverter 6 includes the inverter circuit portion 20 that drives the electric motor 2 and the noise filter circuit portion 30 that reduces electromagnetic noise.

The inverter circuit portion 20 is formed to convert DC power supplied from the in-vehicle battery via the HV connector 9 into three-phase AC power and supply the power to a stator coil 2a of the electric motor 2 via a power supply line 10 extending through the partition wall 77. Therefore, the inverter circuit portion 20 includes six power switching elements 21 and an inverter control substrate 25 on which a control circuit 23 that controls the six power switching elements 21 is mounted.

The six power switching elements 21 are placed on a first heat dissipation member 11 in a sheet shape installed on the surface of the partition wall 77 facing the inverter accommodation portion 7. In addition, the six power switching elements 21 are fixed in a state of being pressed against the first heat dissipation member 11 by an arm member 12 (see FIG. 1). The arm member 12 is mounted on an arm mounting portion 14 provided inside the inverter accommodation portion 7 with a bolt 13.

The inverter control substrate 25 is formed with a plurality of (here, seven) mounting holes 25a The inverter control substrate 25 is mounted on a plurality of substrate mounting portions 15 provided inside the inverter accommodation portion 7 with a plurality of bolts (not shown). The inverter control substrate 25 is disposed near the cover member 8, i.e., spaced apart from the six power switching elements 21 (see FIG. 1). Therefore, the six power switching elements 21 individually have a lead wire extending toward the inverter control substrate 25, more specifically, a lead wire extending through the inverter control substrate 25. These lead wires are soldered to the inverter control substrate 25, and thus, the six power switching elements 21 and the inverter control substrate 25 are electrically connected to each other.

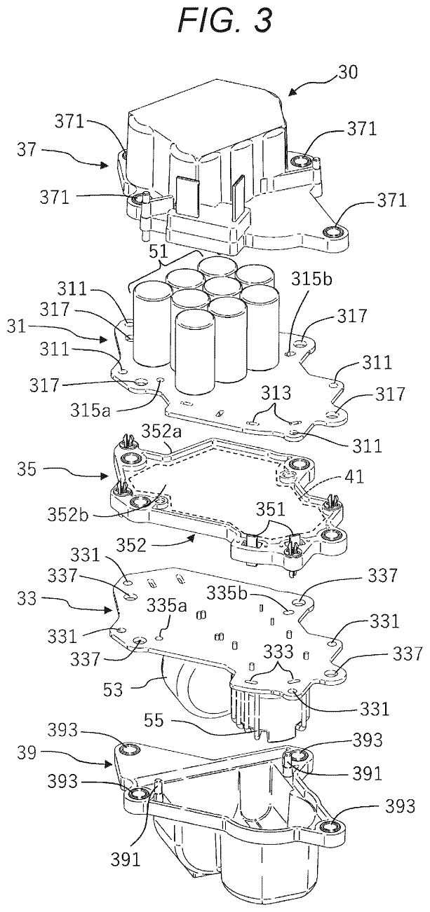

The noise filter circuit portion 30 is disposed between the inverter circuit portion 20 and the HV connector 9. FIG. 3 is an exploded perspective view of the noise filter circuit portion 30.

Referring to FIGS. 1 and 3, the noise filter circuit portion 30 includes a first filter circuit board 31 and a second filter circuit board 33. Note that the first filter circuit board 31 is an example of a first circuit board, and the second filter circuit board 33 is an example of a second circuit board.

On one surface of the first filter circuit board 31, a plurality of (here, nine) electrolytic capacitors 51 having a relatively large cylindrical shape is mounted in an upright state for electromagnetic noise countermeasures. Note that one surface of the first filter circuit board 31 is an upper surface in FIGS. 1 and 3 and faces the cover member 8 when the first filter circuit board is accommodated in the inverter accommodation portion 7.

Although not clearly shown in the drawing, a plurality of electronic components smaller than the plurality of electrolytic capacitors 51 is also mounted on the first filter circuit board 31. At least some of these small-sized electronic components are mounted on the other surface of the first filter circuit board 31, more specifically, on the other surface of the first filter circuit board 31 at positions avoiding a range below the plurality of electrolytic capacitors 51. Note that the other surface of the first filter circuit board 31 is the lower surface in FIGS. 1 and 3, which faces the bottom portion of the inverter accommodation portion 7 when the first filter circuit board is accommodated in the inverter accommodation portion 7.

On one surface of the second filter circuit board 33, a relatively large normal mode choke coil 53, a common mode choke coil 55, an X capacitor, and a Y capacitor (not shown) are mounted for electromagnetic noise countermeasures. Note that one surface of the second filter circuit board 33 is a lower surface in FIGS. 1 and 3, which faces the bottom of the inverter accommodation portion 7 when the second filter circuit board is accommodated in the inverter accommodation portion 7. Here, the normal mode choke coil 53 and the common mode choke coil 55 are exemplified as the coil.

Although not clearly shown in the drawings, a plurality of electronic components smaller than the normal mode choke coil 53, the common mode choke coil 55, the X capacitor, and the Y capacitor is also mounted on the second filter circuit board 33. At least some of these small-sized electronic components are mounted on the other surface of the second filter circuit board 33, more specifically, on the other surface of the second filter circuit board 33 at positions avoiding a range below the normal mode choke coil 53, the common mode choke coil 55, the X capacitor, and the Y capacitor. Note that the other surface of the second filter circuit board 33 is the upper surface in FIGS. 1 and 3, which faces the cover member 8 when the second filter circuit board is accommodated in the inverter accommodation portion 7.

Hereinafter, for simplification of description, the normal mode choke coil 53, the common mode choke coil 55, the X capacitor, and the Y capacitor are simply abbreviated as “the normal mode choke coil 53 and the common mode choke coil 55”.

The first filter circuit board 31 and the second filter circuit board 33 are electrically connected to each other, and are accommodated in the inverter accommodation portion 7 in a state where the first filter circuit board 31 and the second filter circuit board 33 are overlapped, with the plate-shaped resin member 35 interposed. Specifically, the first filter circuit board 31 and the second filter circuit board 33 are electrically connected to each other, and are accommodated in the inverter accommodation portion 7 in a state where the other surface of the first filter circuit board 31 and the other surface of the second filter circuit board 33 are disposed back to back, with the plate-shaped resin member 35 interposed. Hereinafter, this will be described in detail.

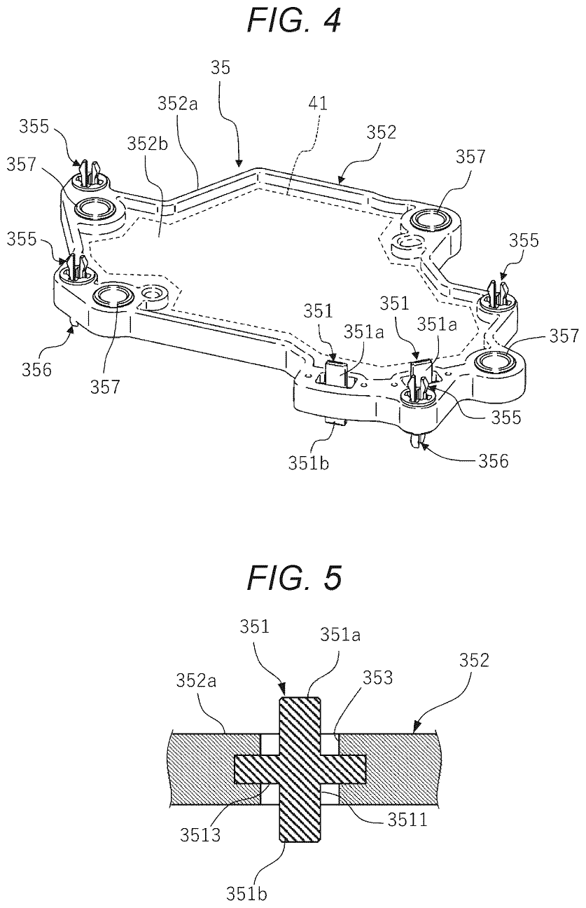

First, an example of the resin member 35 will be described with reference to FIG. 4. The resin member 35 includes a pair of bus bars 351 that electrically connects the first filter circuit board 31 to the second filter circuit board 33, a main body 352 that is made of a resin and holds the pair of bus bars 351, and a shielding plate 41 that is made of a metal and disposed inside the main body 352 and shields electromagnetic noise. In other words, the resin member 35 includes the pair of bus bars 351 and incorporates the shielding plate 41. Specifically, the resin member 35 is formed as a resin molded body in a plate shape, into which the pair of bus bars 351 and the shielding plate 41 are inserted. In addition, the resin member 35 is formed in a shape following the outer shape of the first filter circuit board 31 (outer shape that substantially matches).

The main body 352 of the resin member 35 is formed in a shape in which a peripheral edge portion 352a having a predetermined width is raised on both sides in the thickness direction with respect to an inner portion 352b. That is, both sides of the main body 352, i.e., both surfaces of the resin member 35 are formed in a shape in which the inner portion 352b is recessed with respect to the peripheral edge portion 352a.

The pair of bus bars 351 is disposed at a predetermined interval in the peripheral edge portion 352a of the main body 352. The pair of bus bars 351 individually penetrates the peripheral edge portion 352a of the main body 352 in the thickness direction, and have a first protruding portion 351a protruding from the peripheral edge portion 352a to one side (the upper side in FIGS. 1, 3, and 4) in the thickness direction and a second protruding portion 351b protruding from the peripheral edge portion 352a of the main body 352 to the other side (the lower side in FIGS. 1, 3, and 4) in the thickness direction.

FIG. 5 is a partially enlarged cross-sectional view of the resin member 35, and shows the bus bar 351 and its surrounding portion. The bus bar 351 is formed as a cross-shaped terminal. The bus bar 351 is a conductive portion 3511 that electrically connects the first filter circuit board 31 to the second filter circuit board 33, and includes the conductive portion 3511 that extends through the peripheral edge portion 352a of the main body 352 in the thickness direction, and a held portion 3513 that extends and intersects the conductive portion 3511 and is held by the main body 352. One end portion of the conductive portion 3511 forms the first protruding portion 351a, and the other end portion of the conductive portion 3511 forms a second protruding portion 351b.

Specifically, a through hole 353 that penetrates in the thickness direction is formed in the peripheral edge portion 352a of the main body 352, and the bus bar 351 is disposed in the through hole 353. The conductive portion 3511 of the bus bar 351 extends in the axial direction in the through hole 353, and has one end portion protruding from one side (the upper side in FIG. 5) of the through hole 353 as the first protruding portion 351a and the other end portion protruding from the other side (the lower side in FIG. 5) of the through hole 353 as the second protruding portion 351b. The held portion 3513 extends in the direction orthogonal to the axial direction of the through hole 353, and both end portions are embedded in the peripheral wall of the through hole 353, i.e., in the main body 352, and thus, the held portion 3513 and the bus bar 351 are held by the main body 352.

That is, only both end portions of the held portion 3513 of the bus bar 351 are buried in the main body 352 (i.e., the resin portion), and other portions are exposed from the main body 352. Further, the conductive portion 3511 of the bus bar 351 is not in contact with the peripheral wall of the through hole 353, i.e., the main body 352.

In addition, although not specifically limited, the shielding plate 41 is formed in a shape substantially following the inner portion 352b of the main body 352 as indicated by a broken line in FIGS. 3 and 4.

The first filter circuit board 31 is mounted on the resin member 35 in a state where the other surface on which the plurality of electrolytic capacitors 51 is not mounted is placed and received on one surface (upper surface in FIGS. 1, 3, and 4) of the resin member 35. Specifically, the first filter circuit board 31 is mounted on the resin member 35 in a state where the other surface on which the plurality of electrolytic capacitors 51 is not mounted is placed on the peripheral edge portion 352a on one surface side of the main body 352 of the resin member 35.

On one surface of the resin member 35, a plurality of elastically deformable first engagement members 355 is integrated, which protrudes vertically from here toward the first filter circuit board 31 and is engaged with a plurality of (here, four) first engagement holes 311 (details will be described later) formed in the first filter circuit board 31 by snap-fitting. Specifically, the plurality of first engagement members 355 is erected at intervals in the circumferential direction of the peripheral edge portion 352a on one surface of the main body 352 of the resin member 35.

In addition, in the vicinity of the peripheral edge portion of the first filter circuit board 31, a plurality of first engagement holes 311 is formed at positions corresponding to the plurality of first engagement members 355 of the resin member 35 so as to receive the plurality of first engagement members 355. The first engagement members 355 of the resin member 35 are inserted into and engaged with the first engagement hole 311 of the first filter circuit board 31, and as a result, the first filter circuit board 31 is fixed to the resin member 35. Note that the details of the first engagement member 355 will be described later.

The first filter circuit board 31 is formed with a pair of first bus bar insertion holes 313 that receives a pair of bus bars 351 of the resin member 35. The first protruding portions 351a of the pair of bus bars 351 of the resin member 35 are inserted into the pair of first bus bar insertion holes 313 of the first filter circuit board 31, and the first protruding portions 351a of the bus bars 351 protruding from the first bus bar insertion holes 313 are soldered to the first filter circuit board 31. As a result, the pair of bus bars 351 of the resin member 35 is electrically connected to the first filter circuit board 31.

Here, as described above, the first protruding portion 351a of the bus bar 351 is a part of the conductive portion 3511 of the bus bar 351, and most of the conductive portion 3511 of the bus bar 351 is located inside the through hole 353 and is not in contact with the main body 352. In addition, in the bus bar 351, only the two end portions of the held portion 3513, which are located away from the first protruding portion 351a, are buried in the main body 352. Therefore, the diffusion of heat when the first protruding portion 351a is soldered to the first filter circuit board 31 is suppressed, and as a result, solder quality is stabilized. In addition, for example, the main body 352 is also suppressed from being melted or deformed by heat when the first protruding portion 351a is soldered to the first filter circuit board 31.

Note that the pair of bus bars 351 of the resin member 35 may be provided with a spring member (not shown) so as to be electrically connected to the first bus bar insertion hole 313 of the first filter circuit board 31 by press-fitting. In this manner, it is possible to eliminate the necessity of solder bonding for establishing an electrical connection between the bus bar 351 and the first filter circuit board 31.

The second filter circuit board 33 is mounted on the resin member 35 in a state where the other surface, on which the normal mode choke coil 53 and the common mode choke coil 55 are not mounted, is placed and received on the other surface (the lower surface in FIGS. 1, 3, and 4) of the resin member 35. Specifically, the second filter circuit board 33 is mounted on the resin member 35 in a state where the other surface, on which the normal mode choke coil 53 and the common mode choke coil 55 are not mounted, is placed on the peripheral edge portion 352a on the other surface side of the main body 352 of the resin member 35.

Similarly to the one surface of the resin member 35, a plurality of second engagement members 356 that is elastically deformable is integrated with the other surface of the resin member 35. The plurality of elastically deformable second engagement members 356 vertically protrudes from the other surface toward the second filter circuit board 33, and engages with a plurality of (here, four) second engagement holes 331 (details will be described later) formed in the second filter circuit board 33 by snap-fitting. However, only two of them are shown in FIG. 4. Specifically, the plurality of second engagement members 356 is erected at intervals in the circumferential direction of the peripheral edge portion 352a on the other surface of the main body 352 of the resin member 35. Here, the second engagement member 356 is disposed coaxially with the first engagement member 355 with respect to the plate surface of the main body 352 of the resin member 35. That is, the first engagement member 355 and the second engagement member 356 are disposed coaxially with the plate surface of the main body 352 of the resin member 35.

In addition, in the vicinity of the peripheral edge portion of the second filter circuit board 33, a plurality of second engagement holes 331 is formed at positions corresponding to the plurality of second engagement members 356 of the resin member 35 so as to receive the plurality of second engagement members 356. The second engagement members 356 of the resin member 35 are individually inserted into and engaged with the second engagement hole 331 of the second filter circuit board 33, and as a result, the second filter circuit board 33 is fixed to the resin member 35. Note that the details of the second engagement member 356 will be described later.

The second filter circuit board 33 is formed with a pair of second bus bar insertion holes 333 that receives a pair of bus bars 351 of the resin member 35. The second protruding portions 351b of the pair of bus bars 351 of the resin member 35 are inserted into the pair of second bus bar insertion holes 333 of the second filter circuit board 33, and the second protruding portions 351b of the bus bars 351 protruding from the second bus bar insertion holes 333 are soldered to the second filter circuit board 33. As a result, the pair of bus bars 351 of the resin member 35 are electrically connected to the second filter circuit board 33.

Here, as described above, the second protruding portion 351b of the bus bar 351 is a part of the conductive portion 3511 of the bus bar 351, and most of the conductive portion 3511 of the bus bar 351 is located inside the through hole 353 and is not in contact with the main body 352. In addition, only the two end portions of the held portion 3513, which are located away from the second protruding portion 351b, are buried in the main body 352 in the bus bar 351. Therefore, the diffusion of heat when the second protruding portion 351b is soldered to the second filter circuit board 33 is suppressed, and as a result, solder quality is stabilized. In addition, for example, the main body 352 is also suppressed from being melted or deformed by heat when the second protruding portion 351b is soldered to the second filter circuit board 33.

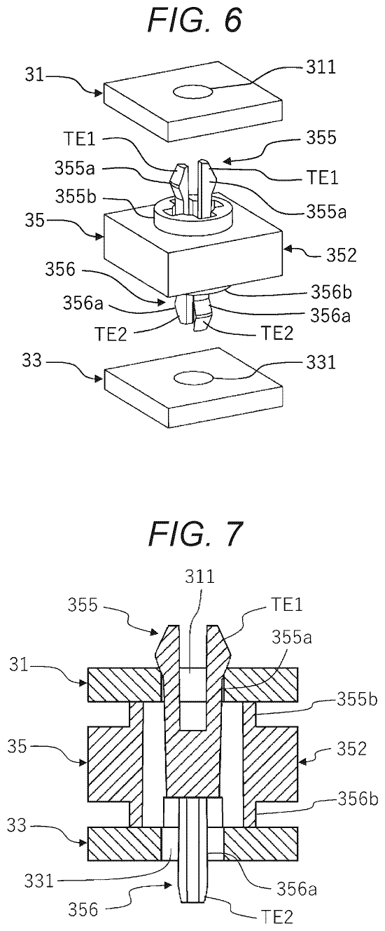

As shown in FIGS. 6 and 7, the first engagement member 355 has two engaging claws 355a that extend perpendicularly to the plate surface of the main body 352 of the resin member 35 and that are disposed axially symmetrically. The two engaging claws 355a each have a rectangular cross-sectional portion vertically rising from the plate surface of the main body 352 of the resin member 35 and a tip end portion TE1 in a triangular shape bulging outward from the rectangular cross-sectional portion. The outer peripheral surfaces of the tip end portions TEI of the two engaging claws 355a are formed in a shape following the inner surface of the first engagement hole 311 of the first filter circuit board 31 in the free state, i.e., in an arc shape following the inner surface of the first engagement hole 311. Here, the free state is a state where no external force other than gravity acts on the first engagement member 355.

Therefore, in the process in which the first engagement member 355 engages with the first engagement hole 311, the entire surface of the tip end portions TE1 of the two engaging claws 355a abuts on the inner surface of the first engagement hole 311, and thus, the tip end portions TEI of the two engaging claws 355a are elastically deformed so as to approach each other by the force of pushing the first engagement member 355 into the first engagement hole 311. Therefore, the force of pushing the first engagement member 355 into the first engagement hole 311 can be efficiently used, and the first engagement member 355 can be easily and reasonably engaged with the first engagement hole 311 of the first filter circuit board 31. Note that in a state where the first engagement member 355 is completely engaged with the first engagement hole 311, the tip end portions TE1 of the two engaging claws 355a penetrate the first engagement hole 311, and the two engaging claws 355a return to the natural state by elasticity, and thus, the engagement state between the two is not easily released. Here, in the case of releasing the engagement of the first engagement member 355 with the first engagement hole 311 of the first filter circuit board 31, for example, the tip end portions TE1 of the two engaging claws 355a may be deformed to approach each other by an external force, and the first engagement member 355 may be pulled out from the first engagement hole 311 in this state.

In addition, a base 355b that receives the first filter circuit board 31 is integrated with the base end of the first engagement member 355. The shape of the base 355b is not limited to the cylindrical shape as shown in FIG. 6, and may be any shape, such as a triangular prism shape or a quadrangular prism shape.

Similarly to the first engagement member 355, the second engagement member 356 has two engaging claws 356a disposed axially symmetrically while extending perpendicularly to the plate surface of the main body 352 of the resin member 35. The two engaging claws 356a each have a rectangular cross-sectional portion vertically rising from the plate surface of the main body 352 of the resin member 35 and a triangular tip end portion TE2 bulging outward from the rectangular cross-sectional portion. The outer peripheral surfaces of the tip end portions TE2 of the two engaging claws 356a are formed in a shape following the inner surface of the second engagement hole 331 of the second filter circuit board 33 in the free state, i.e., in an arc shape following the inner surface of the second engagement hole 331. In addition, a base 356b that receives the second filter circuit board 33 is integrated with the base end of the second engagement member 356. The shape of the base 356b is not limited to the cylindrical shape as shown in FIG. 6, and may be any shape, such as a triangular prism shape or a quadrangular prism shape. Note that since the operation and effect of the second engagement member 356 are similar to the operation and effect of the first engagement member 355, the detailed description will be omitted. Refer to the operation and effect of the first engagement member 355, if necessary.

The two engaging claws 355a of the first engagement member 355 and the two engaging claws 356a of the second engagement member 356 are disposed with a phase difference of an angle of 90° about an axis perpendicular to the plate surface of the main body 352 of the resin member 35. Therefore, when the first engagement member 355 engages with the first engagement hole 311 of the first filter circuit board 31 and the second engagement member 356 engages with the second engagement hole 331 of the second filter circuit board 33, the resin member 35 is positioned with respect to the first filter circuit board 31 and the second filter circuit board 33.

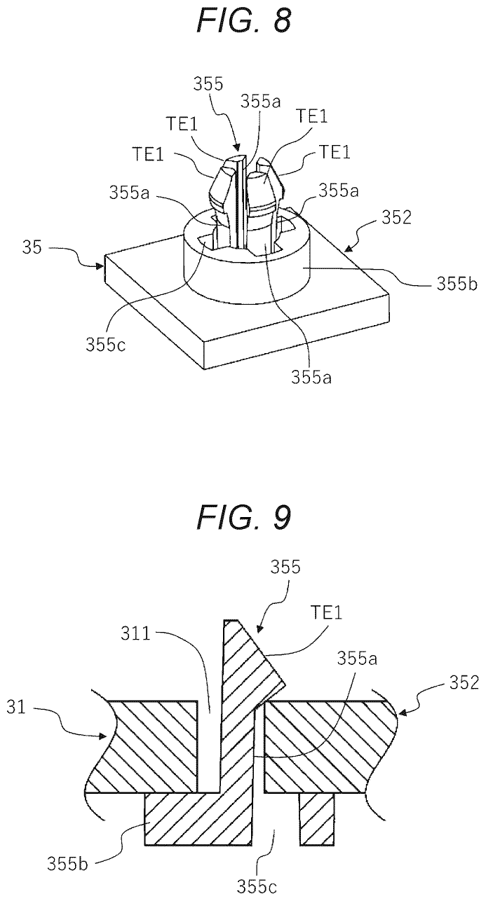

In the case in which the first engagement member 355 and the second engagement member 356 are not coaxially disposed or the noise filter circuit portion 30 includes only one circuit board, the first engagement member 355 (or the second engagement member 356) may be formed as follows. That is, as shown in FIG. 8, the first engagement member 355 includes four engaging claws 355a disposed axially symmetrically while extending perpendicularly to the plate surface of the main body 352 of the resin member 35. Other structures of the first engagement member 355 are similar to those described above, and thus the detailed description will be omitted. Here, the number of the engaging claws 355a of the first engagement member 355 is not limited to four, and may be multiple numbers, three, five, or more. In this manner, when the first engagement member 355 is engaged with the first engagement hole 311 of the first filter circuit board 31 by snap-fitting, the first filter circuit board 31 and the resin member 35 can be positioned by the three or more engaging claws 355a of the first engagement member 355. Note that since the second engagement member 356 has the same structure as the first engagement member 355, the detailed description will be omitted.

In the first engagement member 355 (the same applies to the second engagement member 356) as shown in FIG. 8, since the other engagement members are not coaxially disposed with the resin member 35 interposed, a punching hole 355c may be formed in the base 355b at a portion superimposing the tip end portion TE1 of the engaging claw 355a when viewed from the direction perpendicular to the plate surface of the main body 352 of the resin member 35. As shown in FIG. 9, the punching hole 355c penetrates from one surface to the other surface of the main body 352 of the resin member 35. In this manner, as shown in FIG. 10, when the first engagement member 355 is integrally molded using a first mold MLD1 and a second mold MLD2, which are separable, the first mold MLD1 and the second mold MLD2 can be released in one direction in which the engaging claw 355a of the first engagement member 355 extends. Therefore, a slide mold that complicates the mold is eliminated, and the cost of the mold can be reduced.

In this manner, the first filter circuit board 31 and the second filter circuit board 33 are integrated with the resin member 35, and the first filter circuit board 31 is electrically connected to the second filter circuit board 33. Therefore, when the first filter circuit board 31 and the second filter circuit board 33 are mounted on the resin member 35, thermal caulking becomes unnecessary, and this can avoid thermal influence on the first filter circuit board 31 and the second filter circuit board 33. In addition, as described above, by devising the shapes of the tip end portions of the first engagement member 355 and the second engagement member 356, this enables easy, reasonable engagement of the first engagement hole 311 of the first filter circuit board 31 with the second engagement hole 331 of the second filter circuit board 33. Consequently, it is possible to avoid damage to the first filter circuit board 31 and the second filter circuit board 33 when the first filter circuit board 31 and the second filter circuit board 33 are fixed to the resin member 35 while being positioned.

In addition, the noise filter circuit portion 30 further includes a first case member 37 and a second case member 39. Here, the first case member 37 is an example of the first resin cover, and the second case member 39 is an example of the second resin cover.

The first case member 37 is formed of, for example, a hard resin. The first case member 37 is mounted on the one surface of the first filter circuit board 31 so as to house and cover the nine electrolytic capacitors 51 mounted on the one surface of the first filter circuit board 31. The first case member 37 is mounted on one surface of the first filter circuit board 31 as follows.

First, a predetermined amount of resin R in a softened state or a molten state is charged inside the first case member 37. Subsequently, the first case member 37 is pressed toward one surface of the first filter circuit board 31, while aligning the first filter circuit board 31 with the first case member 37. The first filter circuit board 31 and the first case member 37 are aligned by inserting two pins (not shown) provided in the first case member 37 into a pin insertion hole 315a and a pin insertion elongated hole 315b formed in the first filter circuit board 31. After that, the resin R charged in the first case member 37 is cured. In this manner, the first case member 37 is fixed to one surface of the first filter circuit board 31. Further, a gap inside the first case member 37, i.e., a gap between the plurality of electrolytic capacitors 51 and a gap between the electrolytic capacitor 51 and the first case member 37 is filled with the resin R. Note that the resin R is desirably a heat-resistant thermoplastic resin or a thermosetting resin.

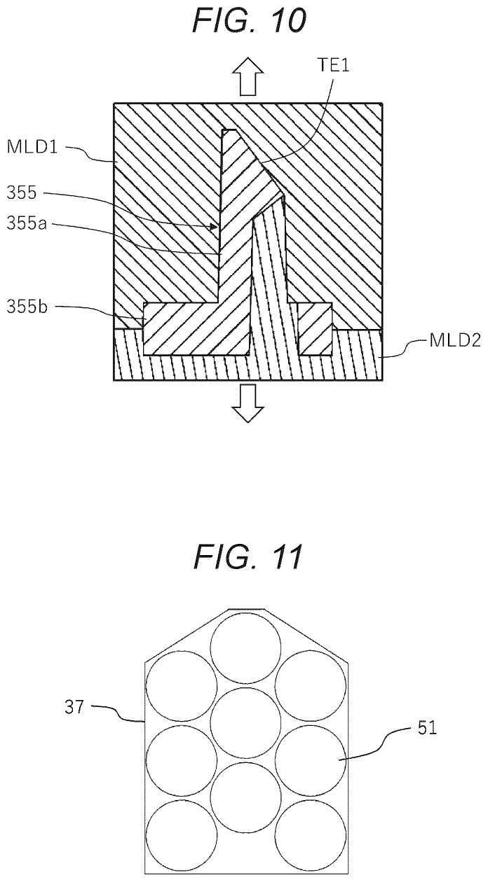

Here, the upper surface of the first case member 37, i.e., the surface located far from the first filter circuit board 31 is formed in a shape corresponding to the layout of the nine electrolytic capacitors 51 mounted on one surface of the first filter circuit board 31. As shown in FIG. 11, it is assumed that the nine electrolytic capacitors 51 are divided into three groups of three columns, and the groups of the columns on both sides of the group of the middle column are disposed at positions offset from the group of the middle column by a half the arrangement interval of the two adjacent electrolytic capacitors 51. In this case, one surface of the first case member 37, when viewed from the mounting direction of the plurality of electrolytic capacitors 51 with respect to the first filter circuit board 31, is formed in a pentagonal shape in which the outlines of the plurality of electrolytic capacitors 51 are connected by a straight line.

In short, the layout of the nine electrolytic capacitors 51 may be devised such that one surface of the first case member 37 viewed from the mounting direction of the plurality of electrolytic capacitors 51 with respect to the first filter circuit board 31 is formed in a pentagonal shape in which the outlines of the plurality of electrolytic capacitors 51 are connected by a straight line. Note that the same applies to other layouts (details will be described later) of the nine electrolytic capacitors 51.

Similarly to the first case member 37, the second case member 39 is formed of, for example, a hard resin. The second case member 39 is mounted on one surface of the second filter circuit board 33 to house and cover the normal mode choke coil 53 and the common mode choke coil 55 mounted on the other surface of the second filter circuit board 33. Similarly to the first case member 37, the second case member 39 is mounted on one surface of the second filter circuit board 33 as follows.

First, a predetermined amount of resin R in a softened state or a molten state is charged inside the second case member 39. Subsequently, the second case member 39 is pressed toward one surface of the second filter circuit board 33, while aligning the second filter circuit board 33 with the second case member 39. The second filter circuit board 33 and the second case member 39 are aligned by inserting the two pins 391 provided in the second case member 39 into a pin insertion hole 335a and a pin insertion elongated hole 335b formed in the second filter circuit board 33. After that, the resin R charged in the second case member 39 is cured. In this manner, the second case member 39 is fixed to one surface of the second filter circuit board 33. Further, a gap inside the second case member 39, i.e., a gap between components such as the normal mode choke coil 53 and the common mode choke coil 55, and a gap between these components and the second case member 39 are filled with the resin R.

In this manner, in addition to the integration of the first filter circuit board 31 with the second filter circuit board 33 via the resin member 35, the first case member 37 is integrated with the second case member 39 as well. That is, the noise filter circuit portion 30 includes the first filter circuit board 31, the second filter circuit board 33, the resin member 35, the first case member 37, and the second case member 39, and a module in which these are integrated is formed.

The noise filter circuit portion 30 thus formed is fixed to a filter mounting portion 17 provided inside the inverter accommodation portion 7 with a plurality of bolts 16 (only one of them is shown in FIG. 1).

Specifically, the first filter circuit board 31, the second filter circuit board 33, the resin member 35, the first case member 37, and the second case member 39 are each formed with a plurality of (here, four) corresponding mounting holes. That is, four first mounting holes 317 are formed in the first filter circuit board 31, and four second mounting holes 337 are formed in the second filter circuit board 33. In addition, four third mounting holes 357 are formed in the resin member 35, four fourth mounting holes 371 are formed in the first case member 37, and four fifth mounting holes 393 are formed in the second case member 39. Here, the third mounting hole 357, the fourth mounting hole 371, and the fifth mounting hole 393 may be formed of a metal cylindrical sleeve inserted during molding.

The noise filter circuit portion 30 is accommodated in the inverter accommodation portion 7 in a state where the second case member 39 faces the bottom portion of the inverter accommodation portion 7. The bolt 16 inserted through the fourth mounting hole 371 of the first case member 37, the first mounting hole 317 of the first filter circuit board 31, the third mounting hole 357 of the resin member 35, the second mounting hole 337 of the second filter circuit board 33, and the fifth mounting hole 393 of the second case member 39 in this order is screwed into a screw hole formed in the filter mounting portion 17. As a result, the first filter circuit board 31, the second filter circuit board 33, the resin member 35, the first case member 37, and the second case member 39 are integrally fixed inside the inverter accommodation portion 7.

When the installation of the inverter circuit portion 20 and the noise filter circuit portion 30 in the inverter accommodation portion 7 is completed, the cover member 8 is mounted on the peripheral wall 73 of the inverter accommodation portion 7.

Here, as shown in FIG. 12, a first heat dissipation sheet 18 is mounted on one surface of the first case member 37 of the noise filter circuit portion 30. The first heat dissipation sheet 18 increases the amount of heat transfer from the noise filter circuit portion 30 to the cover member 8 to improve heat dissipation. In the case in which one surface of the first case member 37 is formed in a pentagonal shape, as shown in FIG. 11, the first heat dissipation sheet 18 mounted here can also be formed in a pentagonal shape. That is, the first heat dissipation sheet 18 can have a shape conforming to the shape of one surface of the first case member 37. In this manner, since the first heat dissipation sheet 18 has a simple shape, when the plurality of first heat dissipation sheets 18 is cut out from a large heat dissipation sheet, a portion to be discarded can be reduced. In addition, since the two corners of the pentagonal shape have an angle of 90°, the reference of the attaching position of the first heat dissipation sheet 18 with respect to the first case member 37 becomes clear, the attaching work by an operator becomes easy, and the attaching work by a robot or the like can also be automated.

On one surface of the second case member 39 of the noise filter circuit portion 30, i.e., a surface facing the bottom portion of the inverter accommodation portion 7, a second heat dissipation sheet 19 is mounted. The second heat dissipation sheet 19 increases the amount of heat transfer from the noise filter circuit portion 30 to the bottom portion of the inverter accommodation portion 7 to improve heat dissipation. The second heat dissipation sheet 19 can have a shape conforming to the shape of one surface of the second case member 39.

In this manner, the noise filter circuit portion 30 is sandwiched between the bottom portion of the inverter accommodation portion 7 and the cover member 8 in a state where the first heat dissipation sheet 18 is interposed between the first case member 37 and the cover member 8 and the second heat dissipation sheet 19 is interposed between the second case member 39 and the bottom portion of the inverter accommodation portion 7. Therefore, the heat generated in the noise filter circuit portion 30 is efficiently transmitted to the bottom portion of the cover member 8 and the inverter accommodation portion 7 via the first heat dissipation sheet 18 and the second heat dissipation sheet 19, and is dissipated from the outer surface, and thus, the heat dissipation of the noise filter circuit portion 30 can be improved. At this time, the bottom wall 71 is cooled by the refrigerant flowing from the inlet 5a into the housing 5, and thus, the heat dissipation of the noise filter circuit portion 30 can be further improved.

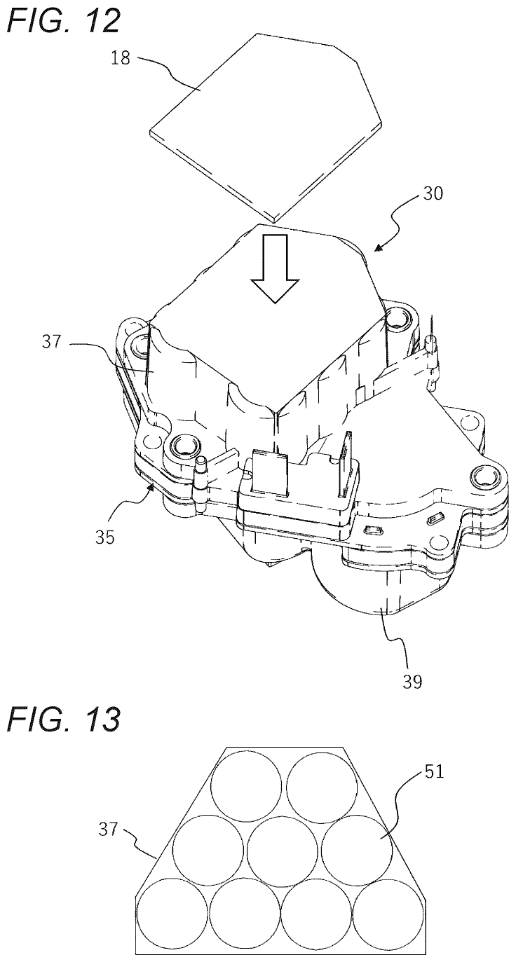

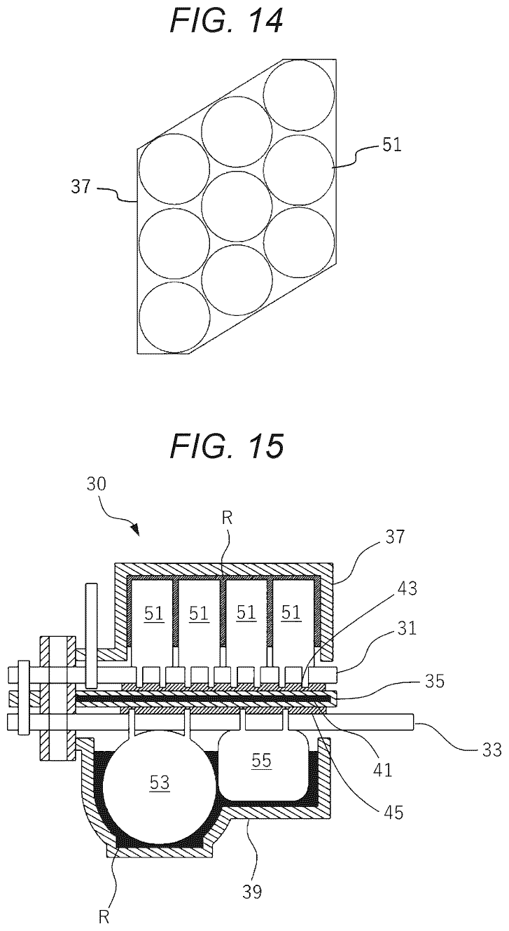

One surface of the first case member 37 of the noise filter circuit portion 30 is not limited to a pentagonal shape, and may be a polygonal shape as shown in FIGS. 13 and 14. In short, the layout of the nine electrolytic capacitors 51 may be devised such that one surface of the first case member 37 viewed from the mounting direction of the plurality of electrolytic capacitors 51 with respect to the first filter circuit board 31 is formed into a polygonal shape in which the outlines of the plurality of electrolytic capacitors 51 are connected by a straight line.

As shown in FIG. 13, when the nine electrolytic capacitors 51 mounted on the one surface of the first filter circuit board 31 are disposed within the range of the trapezoid, the one surface of the first case member 37 can be formed into a trapezoid following the trapezoid. Further, as shown in FIG. 14, when the nine electrolytic capacitors 51 disposed on the one surface of the first filter circuit board 31 are disposed within the range of a substantially parallelogram, the one surface of the first case member 37 can be formed into a substantially parallelogram following the substantially parallelogram. However, in the case of a substantially parallelogram as shown in FIG. 14, in order to clarify a reference for attaching the first heat dissipation sheet 18 to the first case member 37, for example, it is desirable that two corners forming an acute angle have an angle of 90°. Note that although not shown in the drawing, when the nine electrolytic capacitors 51 mounted on the one surface of the first filter circuit board 31 are disposed within a square range, the one surface of the first case member 37 may be a square following the square range.

In short, by devising the layout of the plurality of electrolytic capacitors 51, one surface of the first case member 37 can have a polygonal shape in which at least two corners have an angle of 90°. In the case in which one surface of the first case member 37 is formed in a polygonal shape in which at least two corners have an angle of 90°, the first heat dissipation sheet 18 mounted here can have a shape following the poly gonal shape.

The electric compressor 1 according to the present embodiment can exert the following effects in addition to the above-described effects.

In the electric compressor 1, the noise filter circuit portion 30 includes the first filter circuit board 31 on which the plurality of electrolytic capacitors 51 is mounted, and the second filter circuit board 33 on which the normal mode choke coil 53 and the common mode choke coil 55 are mounted. The first filter circuit board 31 and the second filter circuit board 33 are electrically connected to each other, and are accommodated in the inverter accommodation portion 7 in a state of being stacked back-to-back with the plate-shaped resin member 35 interposed.

That is, the plurality of electrolytic capacitors 51, the normal mode choke coil 53, and the common mode choke coil 55, which are used for electromagnetic noise countermeasures, are dispersedly mounted on the first filter circuit board 31 and the second filter circuit board 33, and the first filter circuit board 31 and the second filter circuit board 33 are disposed above and below with the resin member 35 interposed. Therefore, even in the case in which the noise filter circuit portion 30 increases in size or the number of components increases, it is possible to suppress an increase in the projected area of the filter circuit board constituting the noise filter circuit portion 30, i.e., an increase in the projected area of the inverter accommodation portion 7. Therefore, it is also possible to suppress the restriction on the installation location of the electric compressor 1 and suppress an increase in noise caused by vibration of the cover member 8. In addition, since the plurality of electrolytic capacitors 51, the normal mode choke coil 53, and the common mode choke coil 55 are mounted on separate circuit boards, their thermal interference is suppressed.

Specifically, the plurality of electrolytic capacitors 51 is mounted on one surface of the first filter circuit board 31, and the normal mode choke coil 53 and the common mode choke coil 55 are mounted on one surface of the second filter circuit board 33. The other surface of the first filter circuit board 31 and the other surface of the second filter circuit board 33 are accommodated in the inverter accommodation portion 7 in a state of being disposed to face each other with the resin member 35 interposed. Therefore, the first filter circuit board 31 and the second filter circuit board 33 are each reinforced by the plate-shaped resin member 35, and thus, the earthquake resistance of the filter circuit board, i.e., the noise filter circuit portion 30 is improved.

In addition, the resin member 35 includes the pair of metal bus bars 351 that electrically connects the first filter circuit board 31 to the second filter circuit board 33, and incorporates the shielding plate 41 that shields electromagnetic noise. Therefore, it is unnecessary to separately prepare a component or the like that electrically connects the first filter circuit board 31 to the second filter circuit board 33, and a compact, stable connection between the first filter circuit board 31 and the second filter circuit board 33 can be realized. As a result, a malfunction or the like caused by interference of radiation noise between the first filter circuit board 31 and the second filter circuit board 33 is stopped.

Further, the resin member 35 has a shape following the outer shape of the first filter circuit board 31. Therefore, the resin member 35 functions as an insulating wall between the first filter circuit board 31 and the second filter circuit board 33, and an insulation distance between the first filter circuit board 31 and the second filter circuit board 33 can be secured.

The first filter circuit board 31 is fixed to one surface of the resin member 35 by the first engagement member 355, and the second filter circuit board 33 is fixed to the other surface of the resin member 35 with the second engagement member 356. Therefore, the first filter circuit board 31 and the second filter circuit board 33 can be integrated into a module, and a decrease in the mountability of the noise filter circuit portion 30 on the inverter accommodation portion 7 due to the plurality of filter components mounted on the two circuit boards in a distributed manner is suppressed.

In the small-sized electronic component mounted on the other surface of the first filter circuit board 31, the first filter circuit board 31 is received by the base 355b of the first engagement member 355, and thus, a mounting space is secured. In the small-sized electronic component mounted on the other surface of the second filter circuit board 33, the second filter circuit board 33 is received by the base 356b of the second engagement member 356, and thus, a mounting space is secured. Therefore, by appropriately setting the height of the base 355b of the first engagement member 355 and the height of the base 356b of the second engagement member 356 according to small-sized electronic components, the noise filter circuit portion 30 can be downsized while securing a mounting space for small-sized electronic components.

Here, as shown in FIG. 15, in the noise filter circuit portion 30, a third heat dissipation sheet 43 may be disposed between the first filter circuit board 31 and the resin member 35, and a fourth heat dissipation sheet 45 may be further disposed between the second filter circuit board 33 and the resin member 35. In this case, each of the third heat dissipation sheet 43 and the fourth heat dissipation sheet 45 can have a shape that covers at least a range of electronic components that generate heat. In this manner, the heat generated in the plurality of electrolytic capacitors 51, the normal mode choke coil 53, and the common mode choke coil 55 can be efficiently dissipated.

In the above embodiment, the housing 5 and the inverter accommodation portion 7 are integrally molded. However, it is sufficient that the inverter accommodation portion 7 is provided integrally with the housing 5. For example, the housing 5 and the inverter accommodation portion 7 may be formed separately, and may be combined and integrated.

In the above embodiment, the plurality of electrolytic capacitors 51 is mounted on one surface of the first filter circuit board 31, and the normal mode choke coil 53 and the common mode choke coil 55 are mounted on one surface of the second filter circuit board 33. However, the present invention is not limited to such a structure. The normal mode choke coil 53 and the common mode choke coil 55 may be mounted on one surface of the first filter circuit board 31, and the plurality of electrolytic capacitors 51 may be mounted on one surface of the second filter circuit board 33. However, when such a structure is adopted, in the noise filter circuit portion 30, the other surface of the second case member 39, i.e., the surface facing the bottom portion of the inverter accommodation portion 7 has to be formed in a polygonal shape corresponding to the arrangement of the plurality of electrolytic capacitors 51. In addition, the first heat dissipation sheet 18 is disposed between the first case member 37 and the bottom portion of the inverter accommodation portion 7, and the second heat dissipation sheet 19 is disposed between the second case member 39 and the cover member 8.

Further, in the above embodiment, the resin member 35 has the pair of metal bus bars 351 electrically connecting the first filter circuit board 31 to the second filter circuit board 33, and incorporates the metal shielding plate 41 that shields electromagnetic noise. However, the present invention is not limited to such a structure. The first filter circuit board 31 and the second filter circuit board 33 may be electrically connected by a component different from the bus bar 351, and the shielding plate 41 may be omitted when the level of electromagnetic noise is relatively low.

In addition, in the above embodiment, the resin member 35 is formed in a shape following the outer shape of the first filter circuit board 31. However, the present invention is not limited to such a structure. The resin member 35 may be formed in a shape following the outer shape of at least one of the first filter circuit board 31 and the second filter circuit board 33. Desirably, the first filter circuit board 31, the second filter circuit board 33, and the resin member 35 are formed such that their outer shapes substantially coincide with each other.

In addition, in the above embodiment, the nine electrolytic capacitors 51 are mounted on the first filter circuit board 31 of the noise filter circuit portion 30. However, the number of electrolytic capacitors 51 is not limited to nine and can adopt any numbers. However, the plurality of electrolytic capacitors 51 has to be accommodated within a range of a polygonal shape in which the outlines are connected by a straight line, specifically, a polygonal shape in which at least two corners have an angle of 90°.

It should be noted that those skilled in the art will easily understand that new embodiments can be created by omitting some of the technical ideas of the various embodiments, appropriately combining some of the technical ideas, or replacing some of the technical ideas with well-known techniques.

### LIST OF REFERENCE SIGNS

1 Electric compressor
2 Electric motor
3 Rotating shaft
4 Compression mechanism
5 Housing
6 Inverter
7 Inverter accommodation portion
8 Cover member
18 First heat dissipation sheet
19 Second heat dissipation sheet
20 Inverter circuit portion
30 Noise filter circuit portion
31 First filter circuit board (first circuit board)
33 Second filter circuit board (second circuit board)
35 Resin member
37 First case member (first resin cover)
39 Second case member (second resin cover)
51 Electrolytic capacitor
53 Normal mode choke coil (coil)
55 Common mode choke coil (coil)
75 Opening
351 Bus bar

1. An electric compressor comprising:
an electric motor;
a rotating shaft that is rotated by the electric motor;
a compression mechanism driven by the rotating shaft;
an inverter including an inverter circuit portion that drives the electric motor and a noise filter circuit portion in which a plurality of electrolytic capacitors that reduces electromagnetic noise is mounted on a first circuit board in an upright state;
a housing that accommodates the electric motor, the rotating shaft, and the compression mechanism;
an inverter accommodation portion provided integrally with the housing and having an opening that accommodates the inverter; and
a cover member that closes the opening of the inverter accommodation portion, wherein
the noise filter circuit portion includes a first resin cover that covers a plurality of electrolytic capacitors mounted on the first circuit board,
one surface of the first resin cover, when viewed from a mounting direction of the plurality of electrolytic capacitors on the first circuit board, is formed in a polygonal shape in which outlines of the plurality of electrolytic capacitors are connected by a straight line, and
a first heat dissipation sheet following a shape of one surface of the first resin cover is disposed between the one surface of the first resin cover and one of an inner surface of the cover member and a bottom wall of the inverter accommodation portion.

2. The electric compressor according to claim 1, wherein
at least two corners of a polygonal shape formed on one surface of the first resin cover have an angle of 90°.

3. The electric compressor according to claim 1, wherein
the first heat dissipation sheet is mounted on one surface of the first resin cover.

4. The electric compressor according to claim 1, wherein
the noise filter circuit portion further includes:
a second circuit board on which at least one coil is mounted;
a second resin cover that covers at least one coil mounted on the second circuit board;
a resin member disposed between the first circuit board and the second circuit board with the plurality of electrolytic capacitors and the at least one coil facing in opposite directions; and
a second heat dissipation sheet disposed between one surface of the second resin cover and another of the inner surface of the cover member and the bottom wall of the inverter accommodation portion when viewed from a mounting direction of the at least one coil with respect to the second circuit board.

5. The electric compressor according to claim 4, wherein
the resin member includes a bus bar that electrically connects the first circuit board to the second circuit board.

6. The electric compressor according to claim 1, wherein
the first heat dissipation sheet is disposed between one surface of the first resin cover and an inner surface of the cover member.
